(19) United States
(12) Patent Application Publication
(10) Pub. No.: US 2007/0260423 A1
(43) Pub. Date: Nov. 8, 2007

(54) PHILANTHROPIC FINANCIAL PLANNING TOOL

(76) Inventor: William S. PETRUCK, Toronto (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(21) Appl. No.: 11/747,463

(22) Filed: May 11, 2007

Related U.S. Application Data
(63) Continuation-in-part of application No. 11/095,548, filed on Apr. 1, 2005.
(60) Provisional application No. 60/608,906, filed on Sep. 13, 2004.

(51) Int. Cl. G06F 17/18

(52) U.S. Cl. 702/179

(57) ABSTRACT

A philanthropic planning tool aids in planning multi-year staged donations by showing the tax consequences of a donation and the effect of the donation on an asset base across a number of years. The tax considerations for donations based on cash, securities or a mix of different assets can be displayed to assist the donor in selecting the appropriate donation size and structure.

### CROSS REFERENCE TO RELATED APPLICATIONS

This application is a Continuation-in-part application based on U.S. patent application Ser. No. 11/095,548 filed Apr. 1, 2005 which claims the benefit of priority of U.S. Provisional Patent Application No. 60/608,906 filed Sep. 13, 2004, which is incorporated herein by reference.

### FIELD OF THE INVENTION

The present invention relates generally to financial planning tools. More particularly, the present invention relates to a tool to allow philanthropic donations to be evaluated in the context of financial and estate planning.

### BACKGROUND OF THE INVENTION

Philanthropic solicitation is the lifeblood of numerous charitable organizations. The solicitation of funds from donors allows charitable organizations to operate. Currently fundraisers, gift planners and other financial professionals use various methods to determine how much an individual should give to a charity annually or over a multi-year period. Major gift fundraising is often referred to as an art, as it relies upon cultivation of relationships that allow the fundraiser to ask the other party for financial support.

The manner in which the “ask” is performed is determined based on a number of factors. Research about the potential donor, both about the current asset base and about past donations to various organizations shape the amount of money requested in the ask. Another technique is for the research to involve talking to people familiar with the prospective giver to shape the size of the request. A final approach is to simply request a sum of money not based on prior information.

Often a prospect responds to a donation request with a simple question, “How did you determine the suggested amount?” This is usually related to the requirements of the charity, and only a cursory knowledge of what may be possible for the donor to give.

The actual amount of a donation is shaped in large part by the overall financial profile of the donor. Large donations usually require the involvement of the donor's financial planner, accountant and lawyer. These individuals look after wealth creation, tax minimization, the preservation of wealth, and the transfer of wealth to others, including to future generations. Donors typically must consult each of these professionals serially, which increases the delay between the ask and the gift. Often the consultations require information to be passed back and forth a number of times so that a donor can see the effect of the donation on their financial picture.

The approaches to donation asking are very unscientific, and potential donors tend to be skeptical of requested amounts due to the guess work involved in the process. If an inappropriate amount is requested due to inaccurate information, the donor may be offended or resentful, adversely affecting the eventual donation.

By allowing for the initial ask to be a reasonable amount based on the donor's asset base and income levels, and by providing a detailed picture of both the one time and on-going effects to the donor asset base and annual income, it would be possible to arrive at more soundly derived ask amounts, and to reduce the amount of time between the ask and the gift.

It is, therefore, desirable to provide a system that allows for philanthropic financial planning, while accounting for the effect of a gift on the asset base and annual income of the donor.

### SUMMARY OF THE INVENTION

It is an object of the present invention to obviate or mitigate at least one disadvantage of previous financial modelling tools.

In a first aspect of the present invention there is provided a philanthropic planning tool. The tool can be used to project the financial consequences of a philanthropic donation. The tool includes donor, taxation and economic modelling engines as well as a presentation engine. The donor modelling engine builds a financial model of a donor including a donor asset base. The taxation modelling engine determines the taxation consequences of the philanthropic donation based on the financial model. The economic modelling engine projects future growth of both the asset base based on the financial model, and economic assumptions as well as the financial model, the philanthropic donation, the taxation consequences and economic assumptions. The presentation engine displays the financial model, the taxation consequences and both the future growth projections.

In an embodiment of the present invention, the financial model includes the donor asset base and an annual income, and the donor asset base is preferably segmented by asset type. In another embodiment, the taxation modelling engine includes a taxation regime selector for selecting a taxation regime under which to determine the taxation consequences, which optionally determines the taxation consequences based on an asset type associated with the philanthropic donation. The asset type is preferably selected from a list including cash, securities, bonds, investment certificates and real estate. The tool can also include an optimization engine for selecting a mix of asset types to minimize the cost of the donation based on the financial model, the taxation consequences and the economic assumptions. In another embodiment, the taxation modelling engine is hosted on a server connected to the tool by a data network. In a further embodiment, economic assumptions include inflation and an investment yield that can be different for different asset types. In a further embodiment, the presentation engine includes means to display both the financial projections in either numeric or graphical form.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is an illustration of an interface used to modify a donor profile, economic assumptions and taxation scenarios;

FIG. 2 is an illustration of a numeric display of projected consequences;

FIG. 3 is an illustration of a graphical display of projected consequences;

FIG. 4 is an illustration of a comparison between different asset mixes for the donation;

FIG. 5 is a block diagram illustration a network of the present invention;

FIG. 6 is an illustration of a tool bar embodiment of the present invention

FIG. 7 is a block diagram illustration of the functionality of an application of the present invention;

FIG. 8 is a control/model view diagram of a system of the present invention;

FIG. 9 is a block diagram illustrating a system of the present invention;

FIGS. 10a to 10c are illustrations of a ranking system user input for use with a philanthropic financial planning tool; and

FIG. 11 is a flowchart outlining a method of providing a ranking system.

### DETAILED DESCRIPTION

Generally, the present invention provides a method and system for philanthropic financial planning.

The donation of a large gift to a charitable organization is motivated by a number of factors, including the merit of the charitable organization, the tax consequences of the gift, and the effect of the gift of the asset base and annual income of the giver. A potential donor may be more willing to donate a large amount if it can be demonstrated that over a number of years the net effect on the asset base will be largely offset by the tax benefits of the gift, and the growth in the rest of the donor's asset base.

Because the growth of an asset base is speculative and can vary based on the type of assets held, a fixed asset growth rate can be assumed, or historical information based on different asset mixes can be used to generate a growth calculation. However, to create such a broad predictive method based on the contents of the asset mix, a large amount of data must be accessible. Additionally, because taxation regimes change from jurisdiction to jurisdiction, on both federal and state or provisional levels, and each of these regimes can change with a modification of the tax code, maintaining separate taxation information in a manner that allows for easy updates is essential. The architecture and design of the present invention provides a solution to the problems relating to both the forecasting of asset base growth and differing taxation regimes.

Large donations are often more easily sold as multi-year commitments. This can allow for better tax advantages and reduces the one-time impact for a donor. A staged, multi-year donation also permits the donor's asset base to continue growing to offset the donation. If this is properly conveyed to a potential donor, the reluctance to a structured donation is often overcome. Although the conventional approach is to simply ask for a commitment for a fixed amount over a series of years, this if often perceived by the donor as an expensive donation if the offsetting asset growth and tax deductions are not clearly illustrated.

To overcome donor reluctance, and to allow the donor to easily participate in the donation planning, the present invention builds a financial model of the donor, factoring in both an asset base and an annual income. The mix of the asset base can be reflected in the model to account for liquidity of assets and different investment return ratios for different portions of an asset base. Based on a projected growth rate of the asset base, other factors included in the financial model and the number of years over which the donation will be made, either a fixed annual donation or a varying donation per year can be designed. Using pre-programmed tax considerations, the overall cost and a projected tax savings can be determined. This allows the donor to be shown the after tax effect of the donation.

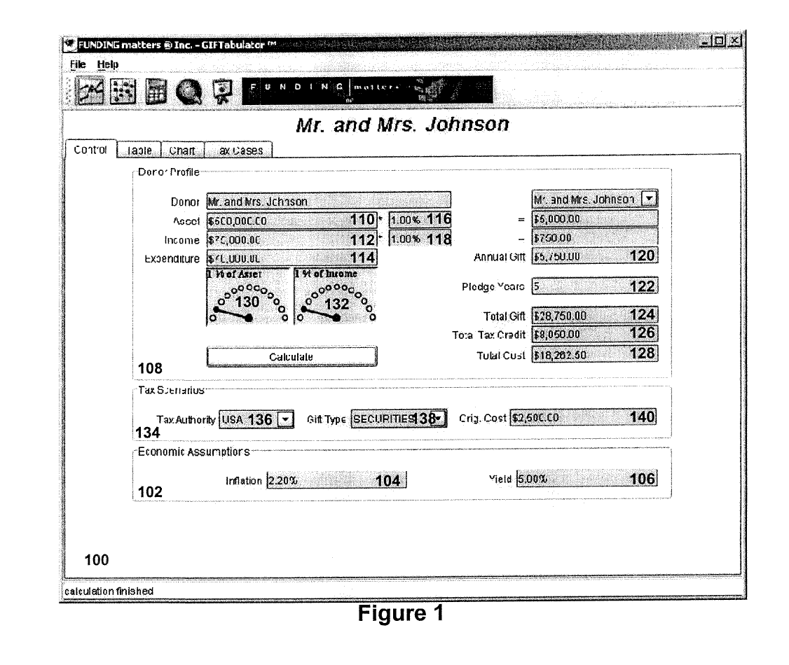

The financial modeling tool of the present invention preferably has a user interface that allows a degree of interactivity so that different percentages of annual income and asset base can be mixed, and the overall value of the donation and the tax consequences can be shown. FIG. 1 illustrates an aspect of an exemplary interface 100. By allowing the donor and the asker to interactively modify economic assumptions 102, such as inflation 104 and the investment yield 106, different projections can easily be generated. The calculations are based on a donor financial model 108 that includes an asset base 110 and annual income 112 and an estimate of the annual expenditures 114. Percentages of the asset base 116 and income 118 can be adjusted to determine the total annual gift 120. The annual gift 120 and the number of years that the gift is staged over 122 can be used to determine the total gift 124, the total tax credit 126 and the overall total cost of the donation 128. These values can be modified by either adjusting the percentages 116 and 118 or by using graphical controls 130 and 132 to adjust the asset and income donation percentages. Selecting a different taxation regime and profile in the taxation scenario 134 can change the tax credit 126. In the taxation scenario 134, a taxation authority 136 can be selected as can the source asset of the gift 138 along with other relevant taxation information such as the original cost of the asset 140. By playing with the asset source 138 different profiles can be generated to account for tax consequences of donating securities, or other assets.

In a presently preferred embodiment, the financial model can account for the fact that certain types of assets have different yields but also have different tax treatments. The easily manipulated mix of donations allows a donor to determine that donation of a higher yielding asset may allow for a lower overall cost due to favourable tax treatment.

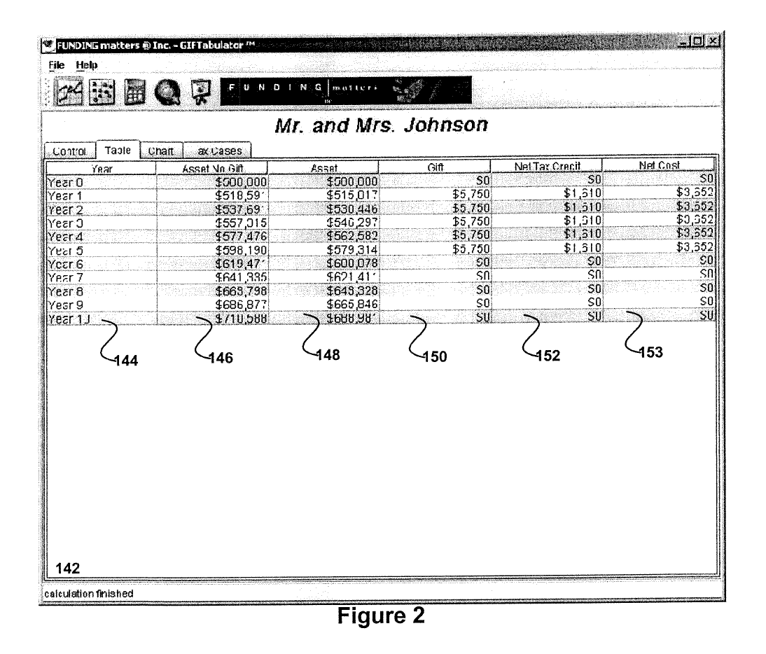

To show the donors the effect of the donation on their asset bases, a multi-year asset grown projection 142 can be presented, as illustrated in FIG. 2. This projection can show the donors what their asset bases will be both with and without the donation. Over a number of years 144 the growth of the asset base if no gift is made 146 can be compared to the asset base after a gift has been made 148. The gift amount 150, the net tax credit 152, and the net cost of the gift 153 can also be shown. Often, a multiyear donation can be shown as having a low overall cost on the long term financial picture of a donor. This is a very helpful tool in encouraging donors, as it clearly illustrates that the donation is relatively painless when viewed with a long term perspective.

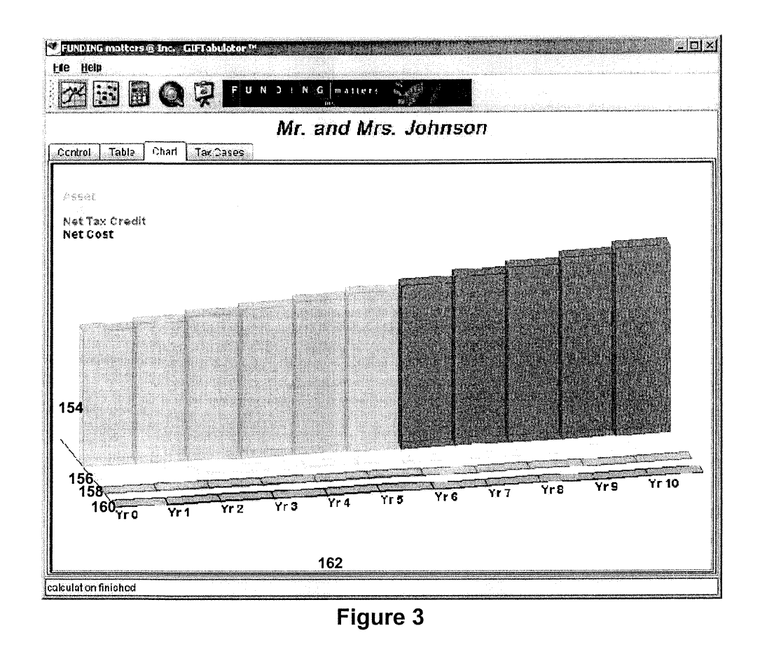

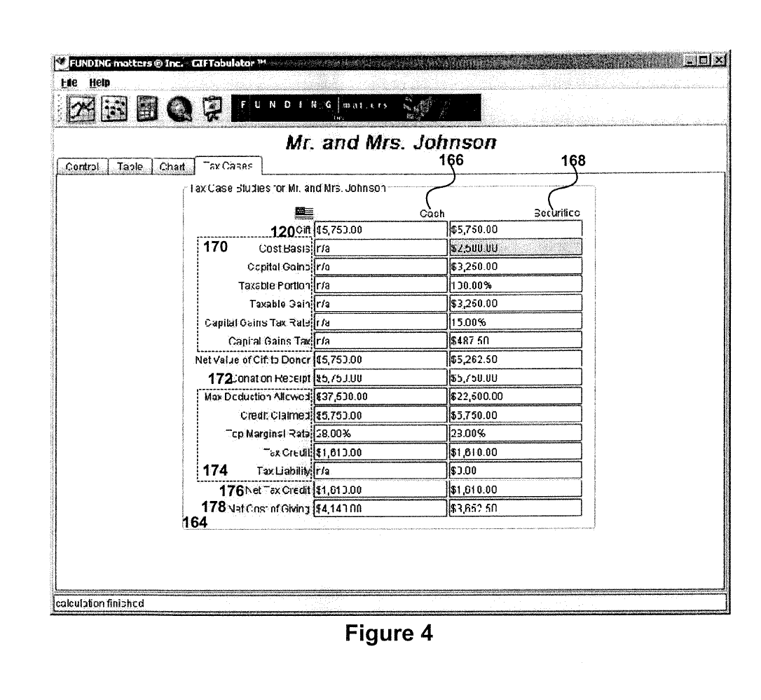

These projections can be shown both numerically, as shown in FIG. 2, and graphically as shown in FIG. 3. In different views, the asset base 154, the gift amount 156, the tax credit 158 and the net cost 160 can be shown in a single graph 162. These graphical views can be presented as lien graphs, bar charts, as a series of pie charts, or in any other graphical display model that illustrates the numbers.

To allow for planning of how the gift is structured, a tax case study 164 can be generated based on the tax scenario 134 previously selected. In the case study 164, the effect of an all cash donation 166 and an all security donation 168 can be generated to demonstrate the different tax treatments and potential yield effects. The annual cost of the gift 120, along with specific information about the source of the gift 170 such as the cost basis, the capital gains attributed to the asset, the taxable portion, the taxable gain, the capital gains tax rate and the overall capital gains tax can be used to determine the net value of the gift to the donor, which can be contrasted to the donation receipt 172. Taxation consequences 174 of the donation receipt 172 can then be used to determine the net tax credit 176 and the net cost of the gift 178. Based on different tax treatments for different asset types, the donor can be shown that donation from one type of asset has better tax consequences.

In another embodiment of the present invention, a mixed donation profile, making use of donations from different asset types, can be generated to allow the donor to see the benefit of various blends of asset donations. An optimization function can be provided to allow the present invention to compute an optimized blend using standards techniques.

To allow the present invention to remain current on the taxation rules of a wide variety of taxation regimes, the present invention can be hosted from a central server so that different taxation profiles can be centrally stored and updated. Client applications with always available connectivity can execute an application hosted by the central server, available through a website interface or other common client server interfaces, while clients without always available connectivity, such as palmtop computing devices, can periodically connect to the server to obtain taxation modules. Limited form factor devices such as palmtop computing devices can synchronize to the central server, to allow the donor profile to be generated on one device, and accessed by other devices connecting to the server.

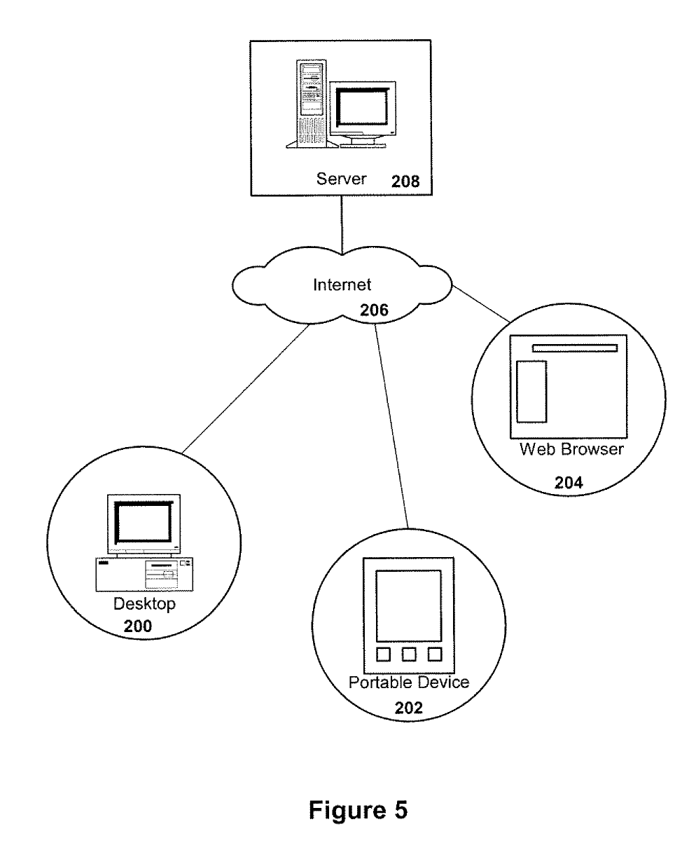

FIG. 5 illustrates an exemplary embodiment of the present invention. A number of different platforms, including a desktop application running on a standard computer platform 200, an application run by a personal digital assistant (PDA) or other palmtop portable computing device 202, and a web based application 204, communicate through a data network 206, such as the Internet, to a centralized server 208. For thin clients that do not have sufficient data processing abilities, such as portable device 202, the server 208 can be used to perform the asset base and taxation calculations. The server 202 can also simply store a series of modules that are accessible to more robust clients for download. This allows for the server 208 to be kept current of tax regime changes, and for the changes to be distributed to the clients as needed, upon connection.

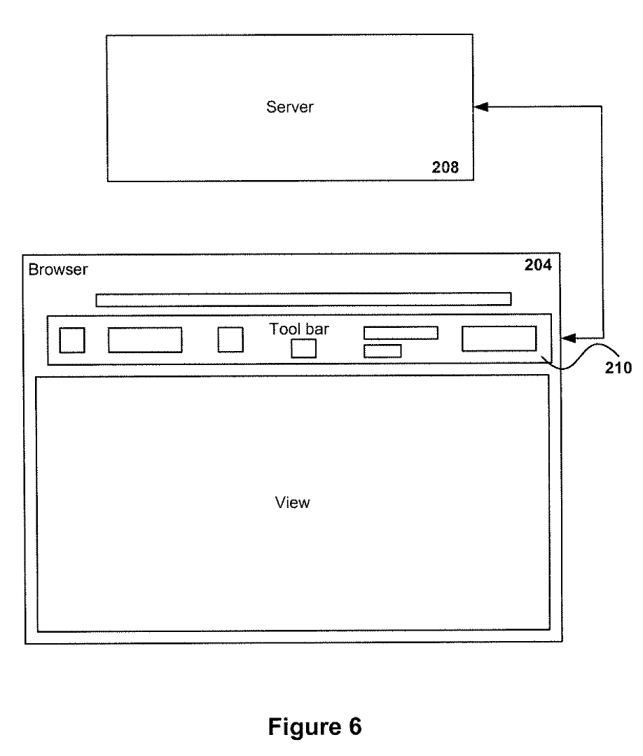

FIG. 6 illustrates an embodiment of the present invention making use of the web based application 204. The server is accessed both through the standard browser interface, and through a tool-bar plug-in 210, so that the user can access a number of related websites, and can securely transmit data to, and receive data from, the central server 208 using a hypertext transfer protocol (http) channel to either transmit donor information to the server for processing, or for receiving the required modules from the server to process a donor model to determine an appropriate gift level.

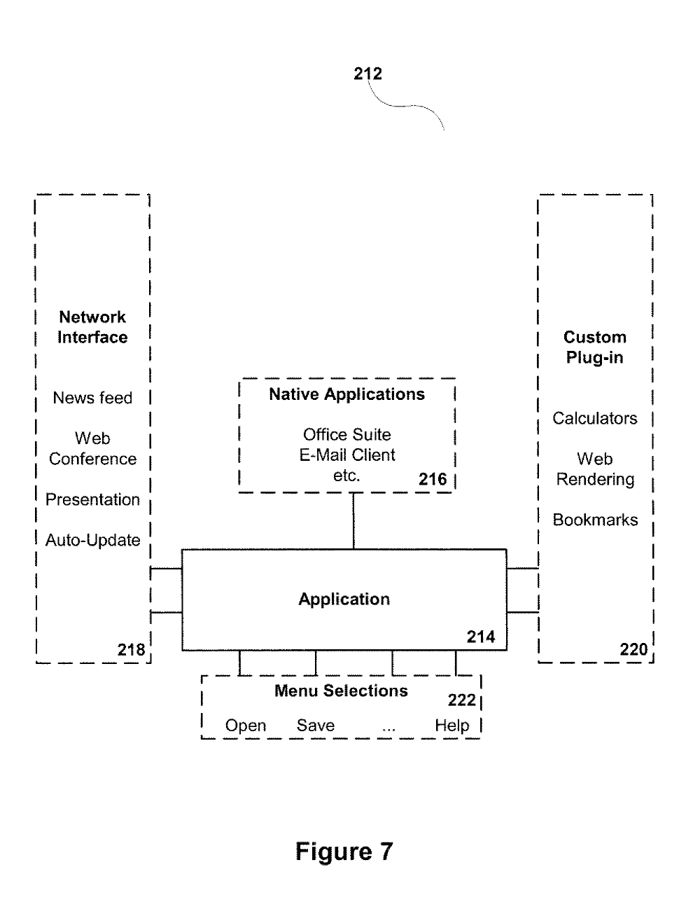

FIG. 7 illustrates an architecture 212 for the deployment of the present invention as a computer executed application. From a central application 214, links can be made to standard desktop applications 216, so that the calculations and forecasts can be provided to conventional presentation, spreadsheet and word processing software to allow the information to be assembled in a fashion that allows financial planners, accountants and lawyers to quickly review the information for the donor. By linking a standard asset growth projection and an up-to-date tax planning forecast generated by the application 214, the fundraiser can provide the potential donor with the projected consequences of a gift, which can then simply be approved by each of the professionals, if necessary, rather than separately generated by each of them.

The application can also interact with the network through a network interface 218 to access news feed and web conference facilities, so that people whose securities transactions and salaries and asset bases are published as part of disclosure rules can be profiled in advance of an ask. This allows the fundraiser to build a preliminary financial model of the potential donor. This model can then be used, preferably in conjunction with historical giving patterns, to determine an appropriate first ask target. Presentation and automated update features can be implemented through the network interface to ensure that the data is presented in a uniform manner and that the taxation models are updated. An interface for customized plug-ins 220 allows the application to take advantage of rendering tools and calculators designed to interact with the application 214.

The features of the application 214, including those offered through the network interface 218 and the plug-in interface 220 can be accessed through a menu system 222.

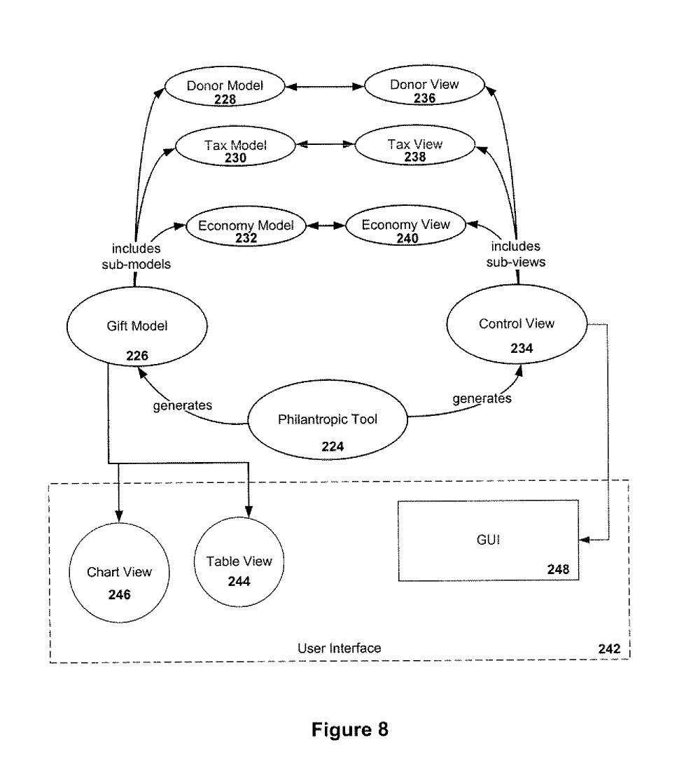

FIG. 8 is a standard Model-View-Control format illustration of the philanthropic tool of the present invention.

Based on publicly available information, the tool 224 generates a gift model 226 that takes the donor profile into account. This model 226 can be stored by the server 208, and transferred between any of the different clients, as shown in FIG. 5. The gift model 226 includes a model of the donor 228, a tax model 230 based on the donor's model 228 and accounting for the jurisdictions in which tax consequences will be generated, and an economy model 232 to allow for asset growth projections based on the donor's present asset mix. These models are presented to the fundraiser as views of the control view 234 generated by the philanthropic tool 224. The control view 234 uses models 228, 230 and 232 to generate donor view 236, tax view 238 and economy view 240. Through the user interface 242 the effects of the gift can be presented numerically in the table view 244 or graphically in the chart view 246. The graphical user interface 248 (GUI) allows the fundraiser to begin the ask process with a first target, based on the donor model, and then work towards new targets by refining the donor model, and ensuring that the correct tax model is selected.

In one embodiment of the present invention, the fundraiser can create the initial model on a desktop computer and save the models to the server. The server can then transfer the models to a PDA based device, so that during a face-to-face meeting with the donor, refinements to the donor model can be made. These refinements can either directly effect the projected gift, or can be simply stored for transmission to the server at a later point in time. By transferring the data to the server, a new set of projections can be calculated and a more accurate model of the donor can be obtained.

This is a vast improvement over the prior art, where the fundraiser was unable to help in the gift planning process. A series of potential gift profiles can be generated, and presented to the donor. These profiles can then be quickly reviewed by advisors instead of requiring the advisors to generate the different profiles on their own. With the pre-generated profiles much of the work is moved from the donor to the fundraiser, a more logical person to be doing the projection work. The philanthropic tool of the present invention can also be used by donors who wish to create a legacy for themselves with their favorite cause or causes.

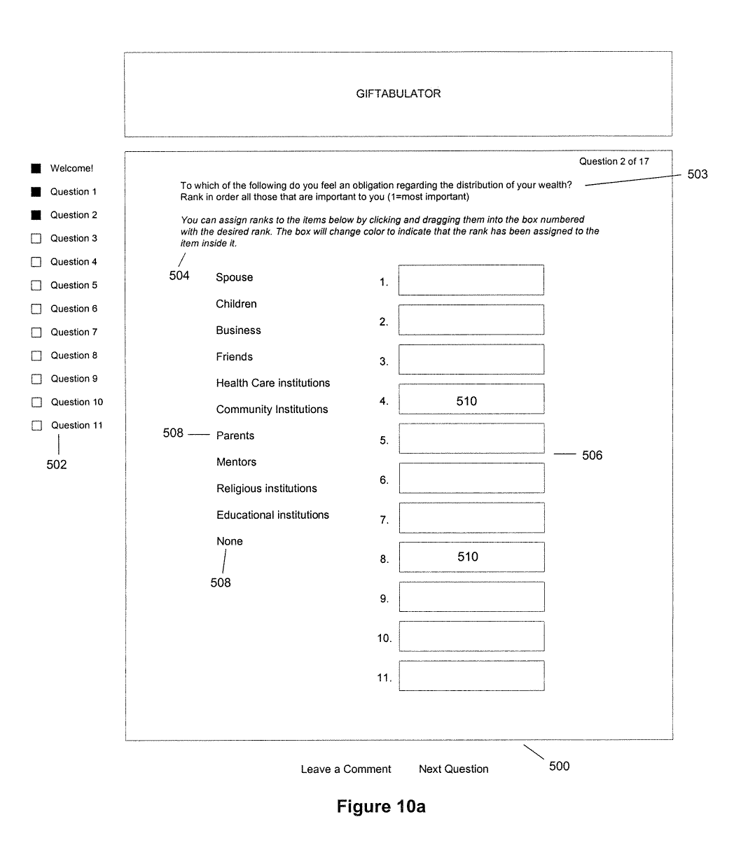

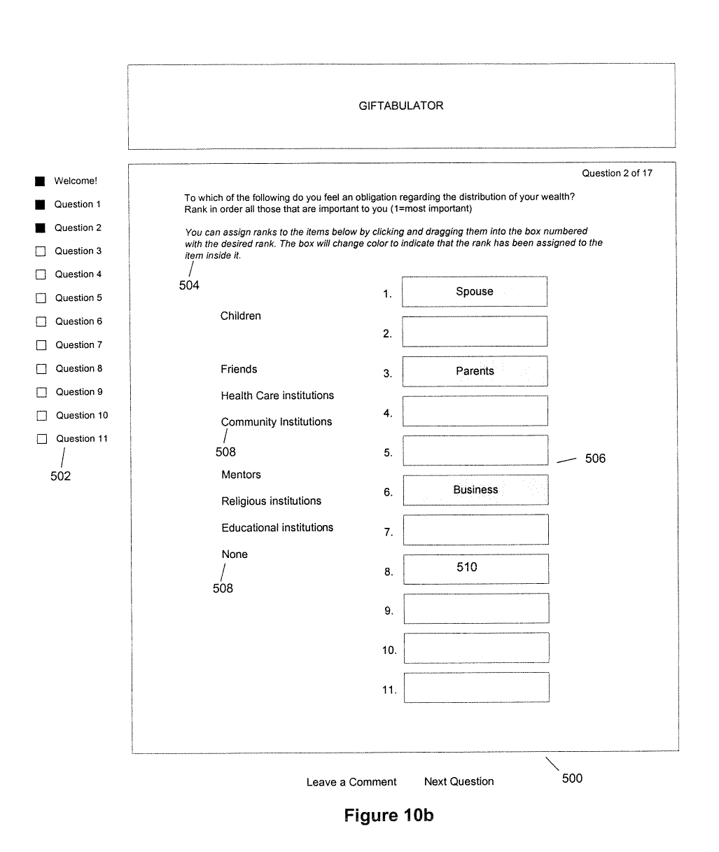

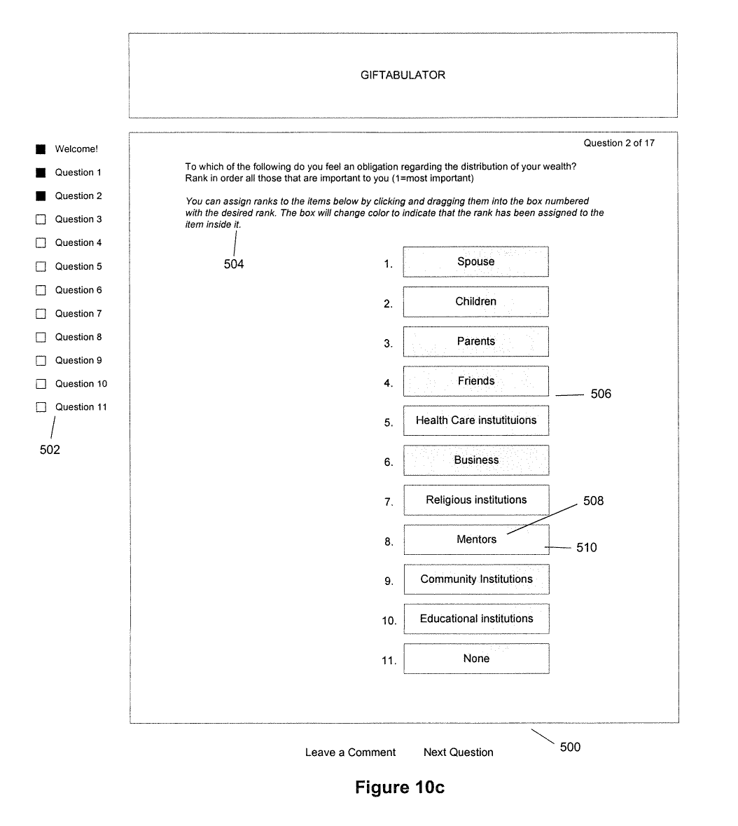

FIGS. 10a to 10c provide illustrations of a graphical display of a ranking system for the philanthropic financial planning tool. FIG. 10a depicts the ranking system prior to user input. FIG. 10b depicts the ranking system after some user input has been received and FIG. 10c depicts the ranking system after the ranking has been completed.

Turning to FIG. 10a, the graphical display 500 of the ranking system 501 includes a question listing section 502, a ranking question section 503 along with an instruction section 504 and a ranking section 506. The question listing section 502, the ranking question section 503 and the instruction section 504 provide information to the user to assist them in the ranking process. Within the ranking section 506, a plurality of choices, or selections, preferably forming a ranking selection list, 508 are available along with a plurality of predetermined ranking areas 510 wherein the plurality of selections 508 may be ranked. Interactivity between a user and the ranking system 501 occurs with the ranking selection list 508 and the ranking areas 510. Furthermore, in the current embodiment, the ranking areas 510 are labelled so that the user may rank the selections in order of importance. Other ranking scenarios are possible including, but not limited to, order of least importance.

In the current embodiment, the number of selections 508 and the number of ranking areas 510 are equal, however, this does not necessarily have to be the case for the invention to operate. At the very least, the number of selections 508 must equal or be greater than the number of ranking areas 510. In this manner, some of the selections may not be ranked.

In the current example, the user is provided with a ranking system for ranking in order of importance, whom they feel obligated to distribute their wealth. As discussed above, the use of the philanthropic financial planning tool assists a user in determining one beneficial method of donating their wealth. In order to understand the user's preferences, the ranking system provides the financial tool further information to assist in the donation determination.

Use of the ranking system is typically outlined in the instruction section 504 along with instructions on how to perform the ranking. The labelling of the plurality of selections 508 for the current ranking include Spouse, Children, Business, Friends, Health Care Institutions, Community institutions, Parents, Mentors, Religious Institutions, Educational Institutions and None while the ranking section includes eleven predetermined ranking areas 510.

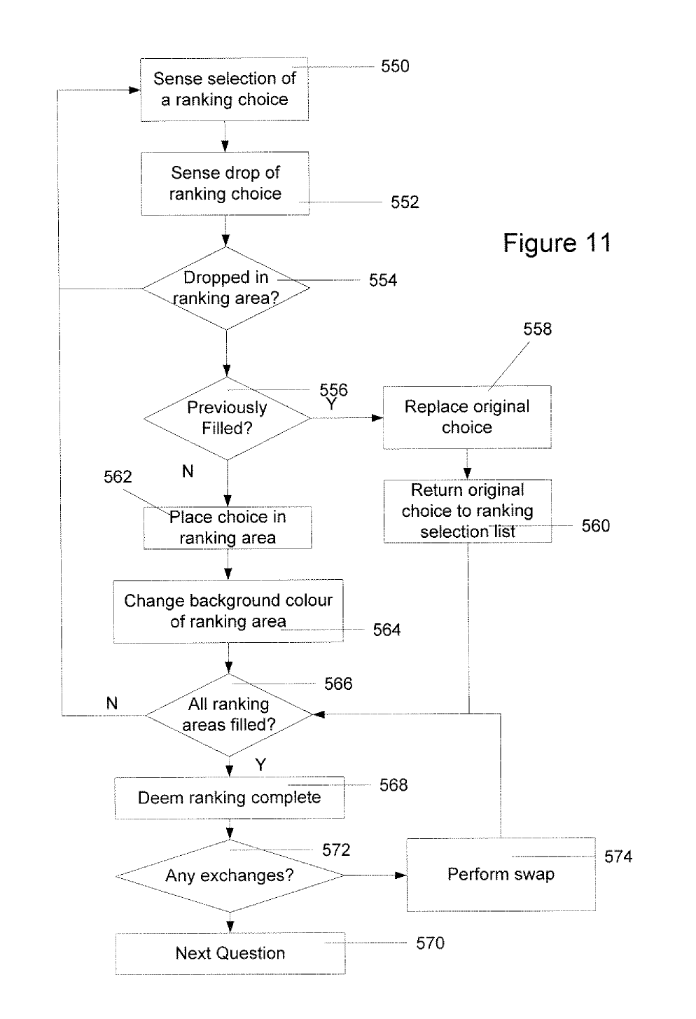

In operation, as schematically shown in the flowchart of FIG. 11, after the user has accessed the ranking system, the user is provided with the instructions in the instruction section 504. After reviewing the instructions, the user interacts with the ranking section 506 whereby the user may then proceed to rank the plurality of selections 508 in their order of importance.

After selecting one of the plurality of selections 508, such as Business, the user may then drag and drop this selection into one of the predetermined ranking areas 510. The ranking system senses that one of the choices has been selected, or clicked on, (step 550) and enables a drag property for the selection such as a flag. The system then senses where the selection is dropped (and disables the drag property) and the predetermined area 510 within which the selection was dropped, or ranked (step 552). A check is then performed to verify whether or not the selection was dropped in one of the ranking areas (step 554). If the coordinates of the location where the selection is dropped do not coincide with the coordinates of one of the ranking areas, the selection is deemed to be not ranked and the ranking system continues to wait for another ranking choice to be selected (step 550). In the present embodiment, each of the ranking areas 510 is allotted a fixed perimeter whereby the maximum and minimum drag limit is preset based on the number of ranking areas 510.

Otherwise, if they coincide, a check is performed to determine whether or not the selection area is previously filled (step 556). If the ranking area has been previously filled, the original selection is replaced by the new selection (step 558) and then returned to the ranking selection list 508 (step 560). After returning the selection to the ranking selection list, the ranking system determines whether or not all of the ranking areas are filled (step 566.I)

Alternatively, if the ranking area is determined to be previously filled (step 556), the user may drag the original ranked selection out of the ranking area 510 and replace it by dragging the current selection 508.

If the ranking area has not been previously filled (as determined in step 556), the choice is centred in the ranking area (step 562) and the background of the ranking area within which the selection was dropped is changed from its original colour, such as white, to a predetermined area filled colour (step 564), such as green in order to more clearly identify its placement to the user and to indicate to the user that the ranking has been accepted.

After the selection has been dropped, the ranking system verifies whether or not all of the predetermined ranking areas have been filled with a selection (step 566). If not, the ranking system continues to wait for another choice to be selected (step 550). Otherwise, the ranking is deemed complete (step 568) and the user may proceed to the next question (step 570). If the user wishes, the user may still update the ranking system to exchange some of the choices (step 572).

If the user wishes to exchange choices (step 572), this is enabled by the sensing of a selection of a choice after ranking has been deemed complete. The exchange is then performed (step 574) in a manner similar to steps 558 and 560 and after confirming that all of the ranking areas are filled, the ranking is once again deemed complete.

During the ranking process, it will be understood that any previously ranked selection may be removed or replaced by another selection as rankings are a dynamic process. If a selection is removed from its ranking, the background of the predetermined area is then returned to its original colour to indicate to the user that the predetermined ranking area is empty. However, in the case of an exchange or a swap, the background does not change colour since the exchange causes the ranking area to be immediately filled.

In an alternative embodiment whereby the label of a ranking selection is longer than the ranking area 510, the label is truncated and trimmed to fit within the ranking area 510.

One skilled in the art will appreciate that because of the connected nature of the present invention, the planning information can be shared between a fundraiser and the donor's advisors in electronic form.

In an alternative embodiment, the ranking system may be used as a voting system.

In one embodiment, the present invention is an automated calculator which determines the ideal annual or multi-year gift to a charity based on income and assets. The calculation accounts for compound annual asset growth and disposable income. A portion of the income and asset base determines a comfortable annual gift for the donor. The annual gift can then be presented either numerically or graphically, with an accounting for the tax credit or savings generated by the gift. Graphs can be generated relating to the Asset base of the donor, the multi-year charitable contribution, tax credit and saving, and the cost of the contribution. The editable nature of the system allows for variables such as interest rate changes and inflation rates to be modified as needed.

When embodied as a web browser plug in, the present invention can have a link to a list of donor prospects and peers. The toolbar allows for the collection of information regarding the donor from public sources, but also allows for the creation of a contact base so that different fundraisers can communicate with each other. By using a back end processing engine, the toolbar can be updated regularly without requiring a large number of upgrade installations.

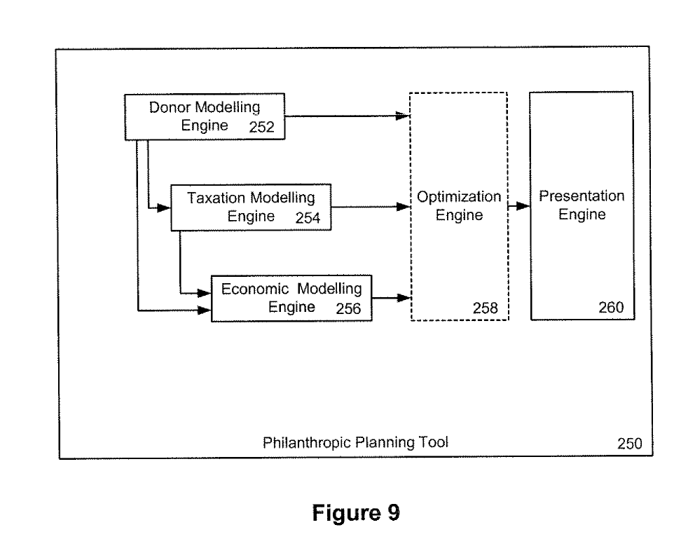

One skilled in the art will appreciate that the present invention can be implemented in a number of ways to offer the same functionality. FIG. 9 illustrates a block diagram embodiment of the present invention that provides an architectural overview. Philanthropic planning tool 250 includes a donor modelling engine 252, a taxation modelling engine 254, and economic modelling engine 256, a presentation engine 260 and optionally includes optimization engine 258. Donor modelling engine 252 builds a financial model of a donor including the donor's asset base and preferably the annual income of the donor. Greater detail that in the financial model allows for a finer degree of control and optimization of the donation model. The taxation modelling engine 254 determines the taxation consequences of the philanthropic donation based on the financial model, and preferably accounts for the type of asset being donated. The economic modelling 256 engine projects the future growth of the asset base based on the economic assumptions, such as inflation and yield values. Preferably the projection allows for a comparison between the asset base with and without the donation over a number of years. Optionally, the optimization engine 258 interacts with the taxation modelling engine 254, the economic modelling engine 256 and the donor modelling engine 252 to determine the best mix of available assets for the donation to either maximize the tax benefits or to minimize the overall cost of the donation. The presentation engine 260 receives information, either from the optimization engine 258 or from the three modelling engines 252, 254 and 256. This information is then displayed so that the donor can see the consequences of various donations.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of providing a ranking system to a user comprising the steps of:
sensing user selection of an item to be ranked;
determining an associated ranking user from a plurality of ranking areas associated with user placement of said item;
changing background colour of said associated ranking area from an original colour to an area filled colour; and
repeating said steps until each of said predetermined ranking areas are filled.

2. The method of claim 1 further comprising the steps of:
sensing that one of said items to be ranked has been removed from one of said predetermined ranking areas; and
changing said background colour of said predetermined ranking area to said original colour.

3. The method of claim 1 wherein said step of determining comprises the steps of:
comparing coordinates of said user placement with a predetermined list of ranking area coordinates; and
determining said associated ranking area based on said step of comparing.

4. The method of claim 3 further comprising the steps of:
determining if said associated ranking area has been previously filled;
replacing an original item with said selected item; and
returning said original item to a selection list.

5. Apparatus for providing a ranking system to a user comprising:
a list of items to be ranked; and
a set of predetermined ranking areas having a background, said background in a designated area empty colour;
whereby when one of said list of items to be ranked is placed in one of said set of predetermined ranking areas, said background is updated to change said designated area empty colour to an area filled colour.

6. The apparatus of claim 5 whereby a number of items to be ranked is equal to or greater than a number of predetermined ranking areas.
